(19) United States
(12) Patent Application Publication
(10) Pub. No.: US 2020/0153503 A1
(43) Pub. Date: May 14, 2020

(54) Modular Systems and Methods for Monitoring and Distributing Power

(71) Applicant: Uncharted Power, Inc., New York, NY (US)

(72) Inventors: Parth Singh, New York, NY (US); Jessica O. Matthews, New York, NY (US); Tanzim Chowdhury, New York, NY (US); Mayurkumar Patel, Jersey City, NJ (US); Fabian Bruegger, New York, NY (US); Benjamin Samuels, Newnan, GA (US); Norma Sosa, New York, NY (US); Jan Drake, Seattle, WA (US); Deanna Kovalcin, New York, NY (US); Daniel Bish, Brooklyn, NY (US)

(21) Appl. No.: 16/596,519

(22) Filed: Oct. 8, 2019

Related U.S. Application Data
(60) Provisional application No. 62/743,455, filed on Oct. 9, 2018.

(51) Int. Cl. H04B 10/079; H04B 10/564; H04B 17/10; G02B 6/44

(52) U.S. Cl. CPC H04B 10/0793; G02B 6/4452; H04B 17/10; H04B 10/564

(57) ABSTRACT

A modular system and method for monitoring and distributing power is disclosed. A container having at least one side surface with an exit port or entrance port, a conduit transmitting through the container and an internal cavity. A container system in the internal cavity has a power distribution system, a data distribution system, and monitoring sensor monitoring container system data. A processor receives the container system data from the monitoring sensor, processes the data and transmits the processed data to the container system.

### TECHNICAL FIELD

The embodiments of this disclosure relate generally to a container system and more specifically a network of container systems to in communication to distribute data and power throughout the network.

### BACKGROUND

The two common construction methods for power transmission systems, overhead lines and underground lines, fail to meet public and private needs for reliable, consistent, affordable, convenient power. Many utility power transmission systems are located above the ground and expose the power transmission systems to damage and failure due to environmental factors. Access to usable power is often unreliable and/or unavailable, particularly in remote or disaster-prone areas of the world. There exists a great unmet need for reliable, consistent, affordable, convenient power. Current underground transmission systems address many causes of unplanned outages, but the financial and resource barriers to entry are too high for those places that need it most. Therefore, the above need is also paired with a need for an affordable and convenient solutions. Even systems that provide regularly consistent access to power can fall victim to unplanned power outages. Finding the source of the outage is often a resource consuming process, and prolonged outages bear harsh economic consequences. Thus, in addition to power access, there also exists a need for an accurate, fast, reliable way to monitor power transmission in order to detect and repair power transmission line faults before end users are negatively impacted.

### SUMMARY

An aspect of an embodiment of the present invention improves systems for power, data, and fluid transmission between modular systems of containers. The containers described herein can function as a replacement for standard flooring, sidewalks, and roads, or can seamlessly blend into the pre-existing environment. Wherever there is or can be ground, the containers can be installed. The containers create a piece of infrastructure, particularly a conduit for embedding technology or hardware in, partially above, or completely above the ground.

In an aspect of an embodiment of the present invention, the system may also include a series of proprietary protocols so that users of the network (or the network itself) can distribute power or data automatically. The modular design and embedded functionality can reduce the cost of installing underground transmission lines for power and/or data. Embedded sensors allow for precise monitoring and issue identification, so repairs can be addressed in hours instead of days, further lowering the cost of maintenance. Power generating devices and data center can also be incorporated into each container, enabling the containers to function autonomously, and as such does not necessarily require linkage to a larger system to provide value to users.

In an aspect of an embodiment of the present invention, when connected to other containers, the system creates a decentralized network for power access and/or data computing and storage that can adapt to the changing needs of the world around it. Features of the containers can include easy installation and repair, ease of repair location identification through smart monitoring, low cost, weather resistance, theft and tamper-resistance, aesthetic appeal, modularity and scalability, and durability, among others. The containers create a system that can also be leveraged for future technological advances, including embedded power generation, scalable power amalgamation, smart power mesh networking, and/or dynamic power or data distribution, enable distributed or parallel computing, among others. Embedded power generation would allow power harnessing devices to be directly integrated into the containers, housing the power source directly in the conduit itself.

The present invention discloses a container that comprises a top surface, a bottom surface and ant at least one side surface oriented between the top and bottom surface. The at least one side surface can define at least one exit port and at least one entrance port to the container. The container can also include at least one conduit transmits through the container. The container defines an internal cavity, and the container system can be located in the internal cavity. The container can also include a power distribution system and a data distribution system. The container can also include at least one monitoring sensor monitoring container system, wherein the container system is housed in a container system enclosure that can withstand environmental conditions.

Another embodiment for the disclosure is a method for monitoring a container. The method can include providing a container having a top surface, a bottom surface and at least one side surface oriented between the top and the bottom surface. An internal cavity is in the container. The method can further include providing a conduit positioned in the internal cavity. The method can comprise transmitting electricity, data, light, solid, liquid, or gas in the conduit. The method can comprise providing a container system. The container system can comprise a power distribution system having a power distribution device that alters a power of the container system. The container system can further comprise a data distribution system having a data distribution device that provides container system data. The container system can also comprise providing at least one monitoring sensor monitoring the container system data. The container system can also comprise a processor receiving the container system data from the at least one monitoring sensor, processing data, and transmitting the processed data. Other embodiments, features, and aspects of the disclosure are described in detail herein and are considered a part of the claimed disclosure. Other embodiments, features, and aspects can be understood with reference to the following detailed description, accompanying drawings and claims.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an exploded isometric view of a container.

FIG. 2 is an isometric exposed view of a container.

FIG. 3 is an isometric exposed view of the container in FIG. 2 with the cover removed.

FIG. 4 is an electrical schematic of the container and container system in FIG. 2.

FIG. 5 is an electrical schematic of tap-in wiring for the container system in FIG. 2.

Shows the flow of voltage monitoring from end to end: tap to microprocessor

FIG. 6 is a power flow diagram of the container and container system

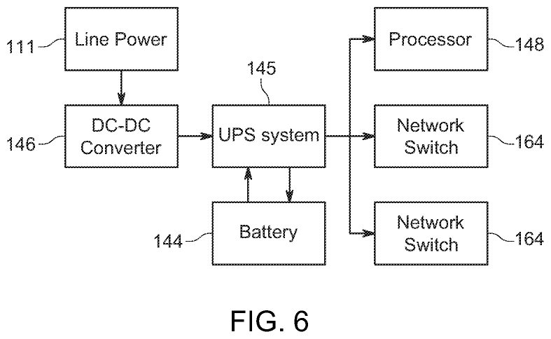

FIG. 7 is a schematic of a dual network for an exemplary distributed data system.

FIG. 8 is a schematic of the software and hardware for the dual network with cloud storage, and a dashboard as the graphical user interface.

FIG. 9 is a display of the graphical user interface display of the distributed data system health.

FIG. 10 is an electrical schematic of the sensor network for the sensor data collection.

FIG. 11 is a flowchart depicting the steps for monitoring a system.

FIG. 12 is an electrical schematic of a smart monitoring system that integrates multiple containers from FIG. 2 in relation to a power source and electrical load.

FIG. 13 is a block diagram depicting the steps to validate data integrity.

### DETAILED DESCRIPTION

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The following description is provided as an enabling teaching of the disclosed articles, systems, and methods in their best, currently known embodiments. To this end, those skilled in the relevant art will recognize and appreciate that many changes can be made to the various aspects of the articles, systems, and methods described herein, while still obtaining the beneficial results of the disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a gasket” can include two or more such gaskets unless the context indicates otherwise.

As used throughout, “substantially” with respect to a measure can refer to a range of values comprising +/−10% or +/−10 degrees. For example, substantially orthogonal, normal, or parallel can include embodiments, where the referenced components are oriented +/−10 degrees of being classified as orthogonal, normal, or parallel respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The containers described herein can function as a replacement for standard flooring, sidewalks, and roads, or can seamlessly blend into the pre-existing environment. The containers can create infrastructure, particularly a conduit for embedding technology or hardware in the ground. The containers, however, can be partially above, or completely above the ground. The containers can be leveraged by a myriad of applications, including power transmission, smart monitoring, and decentralized data centers. Once the system containers are installed, they can serve as container for a ubiquitous and on-demand source of power and/or data that is accessible wherever and whenever power and/or data are needed. The modular design and embedded functionality can reduce the cost of installing underground transmission lines for power and/or data. Further, embedded sensors in the container can facilitate precise monitoring and issue identification, so repairs can be addressed in hours instead of days, further lowering the cost of implementation.

Further, power generating devices and data center components can also be incorporated into each container. In such a configuration, the containers can function autonomously, and may not necessarily require linkage to a larger system to provide value to users. However, when connected to other containers, the system can create a decentralized network for power access and/or data computing and storage that can adapt to the changing needs of the world around it.

Features of the containers can include easy installation and repair, ease of repair location identification through smart monitoring, low cost, weather resistance, theft and tamper-resistance, aesthetic appeal, modularity and scalability, and durability, among others. The containers create a system that can also be leveraged for future technological advances, including embedded power generation, scalable power amalgamation, smart power mesh networking, and/or dynamic power distribution, among others. Embedded power generation would allow power harnessing devices to be directly integrated into the containers, housing the power source directly in the conduit itself. Scalable power amalgamation allows for the efficient collection and storage of smaller packets of power, often generated by multiple different sources. This allows for a larger, more consistent stream of power to become available for use from one output. With both embedded power generation and scalable amalgamation housed within the containers, a complete solution for power generation, storage, and transmission is provided. Smart power mesh networking can utilize the network architecture that the containers are able to create, paired with intelligent communication and power prioritization protocols to efficiently and intelligently transmit power. Short and long-range electricity, the Internet of Things, decentralized cloud computing, edge computing, and data utilization for block chain and autonomous vehicles are a few industry examples that directly benefit from the container described herein and the systems built with them.

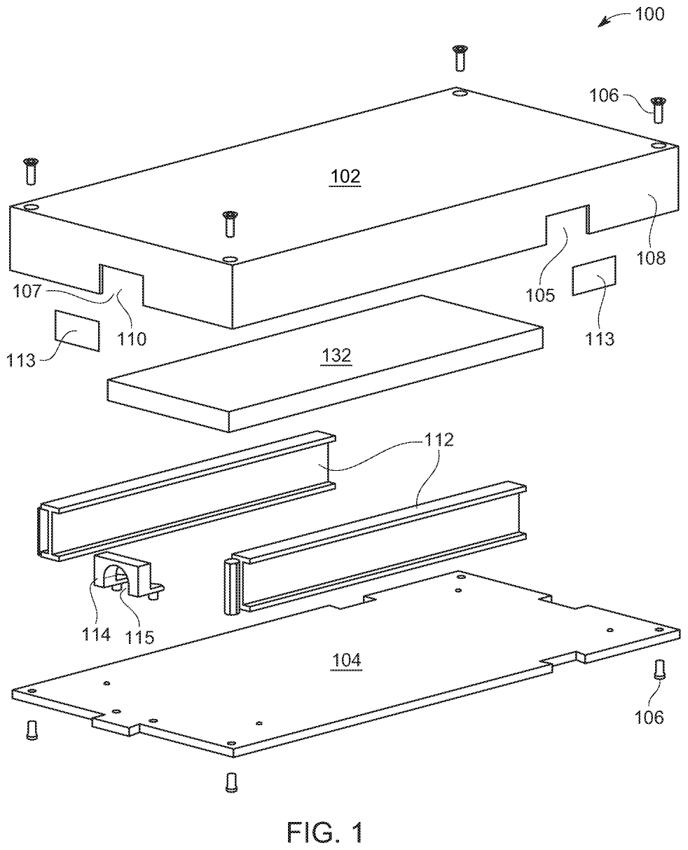

As shown in FIG. 1, the exploded view illustrates the layout of the container 100 comprises a bottom surface 104; a top surface 102; external side surfaces 108; conduit protector 114 provide access to the container's enclosure; and I-beams 112 and fasteners 106 to provide support for the container and increase its stability and robustness. As will be appreciated, any combination of the components mentioned above may be used to construct the containers described herein. In some instances, the container may have additional components (e.g., additional fasteners, supports, or a variety of other options). In some cases, the side surface(s) 108 can permanently connect to the bottom surface 104 and/or the top surface 102 to create one complete piece.

In some instances, the container can comprise fiber reinforced polymer (FRP), one or more plastics, one or metals, a combination thereof, or any other material. Fiber reinforced polymer (FRP) can be used to create an extremely durable container, as well as customizable aesthetics. For example, the top surface 102 can be structured to resemble pavement. While resembling pavement, the top surface 102 can be configured with texturing to ensure that it is a non-slip surface. In some aspects of the container, the top surface 102 can comprise fiber reinforced polymer for durability and structural stability. In a further aspect, the top surface 102 can be customized to blend into an existing environment or create a new appearance or environment within an existing environment. The top surface 102 may also comprise a protective transparent surface exposing underlying lighting devices (such as LEDs), in order to provide an interactive experience or navigation assistance. The top surface 102 is a load-bearing member can bear the weight of large objects and structures ranging from pedestrians to vehicles, for example.

In some cases, the top surface 102 is designed to withstand vertical forces of varying degrees. For example, the I-beam 112 can be integrated into the top surface 102 to allow the top surface 102 to also withstand lateral forces of varying degrees. In some embodiments, the container may comprise a plurality of I-beams. The plurality of I-beams 112 can function as a load-bearing member for the container 200 and allows the container to withstand the application of substantial force, vertical, lateral, or otherwise. The support provided by the plurality of I-beams 112 may allow for the placement of containers in a wide range of locations because of its high weight-bearing potential. Alternatively, the additional I-beams are not required as all surfaces of the container are load-bearing.

As discussed earlier, the one or more side surfaces 108 can have one or more ports that parallel one or more ports in the side surfaces. The number of ports 110 can easily be adjusted depending on the pattern and/or layout that the containers intended for the installation. These ports 110 can be used for the passage of various conduits through the container 100. If the ports 110 are not being used they can be filled used the port plugs 113 a bottom surface 104, and at least one side surface 108. Ports 110 can be oriented between the top and the bottom surface. In a further aspect, the ports 110 can be identified as an entrance port 105 from the container 100 or an exit port 107. In addition, the inside of the container defines an internal cavity 117, which is between the top surface and bottom surface.

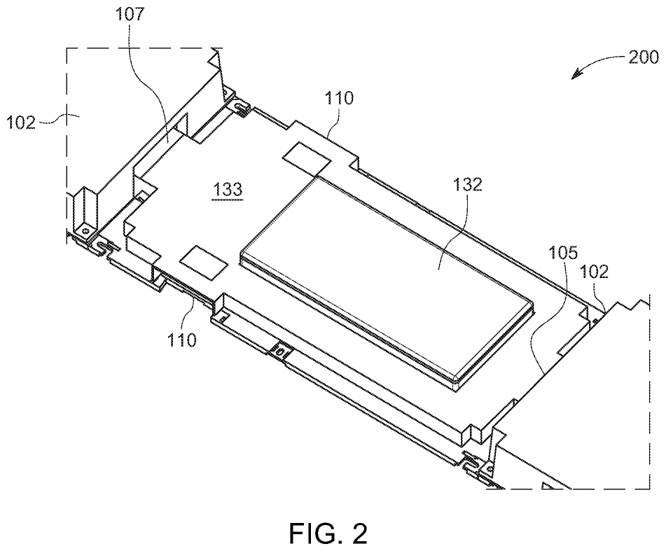

FIG. 2 is an isometric exposed view of a container. In a further aspect, the container system can further comprise a container system cover 133. The container system cover 133 can be used to provide security protection to the conduit 111 in the event that the internal cavity 117 of the container 200 is accessed. In a further aspect, the cover 133 can be configured to provide environmental protection to the conduit 111. The cover 133 can provide protection from environmental factors. For example, the cover 133 can be based on being made of a waterproof and/or ultraviolet resistant material. In other aspects, the cover 133 can provide protection from wind and in yet another aspect the cover can constructed with increased durability to protect the container system 132 in the event of an earthquake or event that affects the load bearing capabilities of the container system 132. The cover 133 can also be constructed to provide a hermetic seal to prevent air, water, or person from accessing the conduit 111. In an embodiment, the container cover 133 can provide insulation from the high-potential conduits 111 and create additional space between the cover 133 and the top surface 102 of the container for other devices, sensors, conduits, and the like.

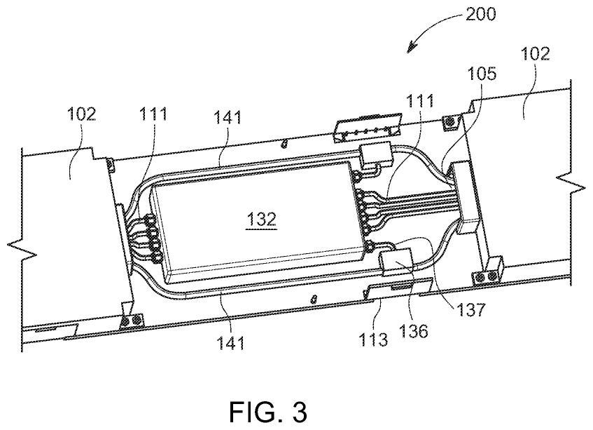

In another aspect if additional lines of transmission are added to the conduit, the potted nodes 136, in FIG. 3, can be integrated to provide access to the conduit. The potted nodes 136 can comprise access points 137 to the conduit that are inert because they may have been sealed off. For example, a potted node 136 can be capped off with an epoxy or resin to prevent access to any components of the conduit 111. When a user seeks to provide an access point 137 to the conduit 111, the potting substance such as but not limited to a plastic, resin, silicone or rubber may be used. In a further aspect, the potted notes can be oriented to align with a port 110 to allow a user to more efficiently be in proximity to the access point 137 of the conduit.

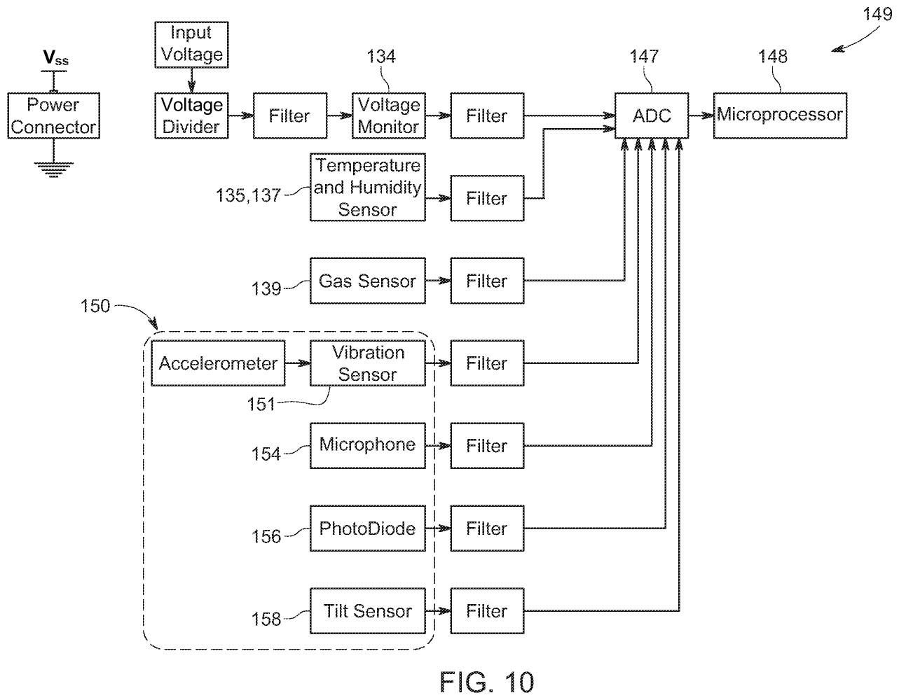

As shown in FIG. 10, the sensor network 149 can comprise a plurality of sensors including the first type of monitoring sensors 134, a second type of monitoring sensors 135 and the collecting type of sensors. In a further aspect the collecting sensors can function to sense data that is external to the container such as environmental conditions. For example, the collecting sensors can be used to measure environmental conditions such as temperature, humidity, light or motion. In a further aspect, FIG. 10 shows an electrical schematic of a plurality of collecting sensors. For example, the collecting sensor can include hardware such as accelerometers to be a vibration sensor 151. The collecting sensors 150 can also comprise a microphone 154. The microphone 154 can be used to listen, to capture audio signal or take a simple decibel reading in proximity to the container 200 or container system 132. In another aspect, the collecting sensor 150 can include a photodiode 156. The photodiode 156 can be used to receive any light signals from outside the container.

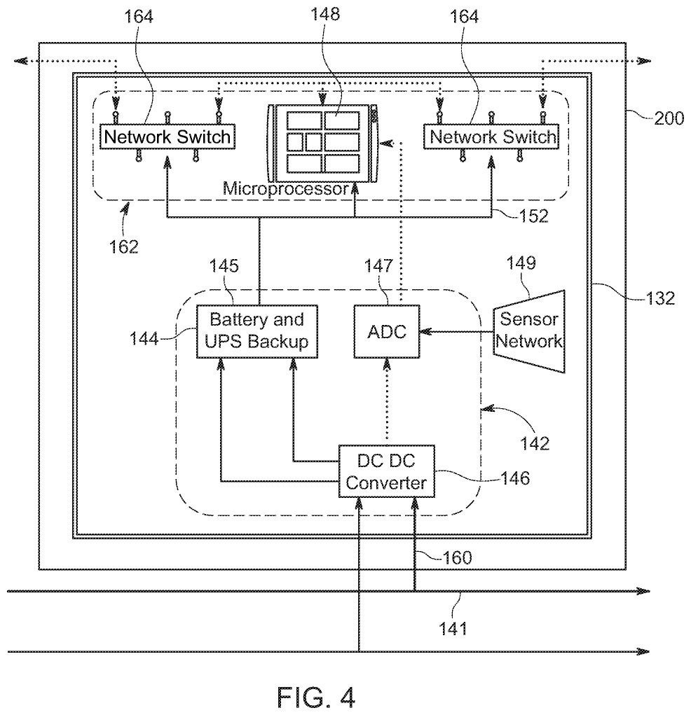

In a further aspect, the container system 132 can comprise multiple sensors for the first type of sensor 134, in FIG. 4, and the second type of sensor 135, when the required measurement needs multiple sensors.

The second type of monitoring sensor 135 to monitor conduit properties. In a further aspect, when the conduit 111 is an electrical passage, the second type monitoring sensor, can be used to measure voltage, current, ground fault. When the second type of monitoring sensor 135 monitors a chemical or fluid conduit properties can include but not be limited to fluid flow, pressure, pH, temperature, or viscosity. When the conduit 111 is a fiber optic cable, the second type of monitoring sensor 135 can monitor conduit properties such as luminosity of the light signal, or reflectivity of the conduit tubing. When the conduit 111 transport solids, temperature, pressure, viscosity, gas exhaust/output, or composition, composition of exhaust, electrical charge, or magnetic fields can be measured or determined by the sensor 135.

In yet another aspect, as shown in FIG. 4, the container system 132 can also include a power distribution device 142. In one aspect the power distribution device 142 can comprise power received from a power conduit. In another aspect the power distribution device 142 can include multiple components to provide the correct power to the container and various container subcomponents including the conduit 111, the sensors in the sensor network. The power conduit 160 can be a localized power source such as a battery 144. In a further aspect, the power conduit 160 can be received into the container from a power transmission line 141.

In a further aspect, the voltage or current supplied by the power transmission line 141 may not always be properly suited to power the container 200 or the container system 132. In order to properly supply the container 200 as sub components the power distribution device 142 can include functionality that alters power of the container system 132. In a further aspect, the power distribution device 142 can comprise multiple components with the purpose of altering power to the container system 132. As shown in FIG. 4, the power distribution device 142 can include a power supply 144, wherein the power supply can be a battery. In a further aspect, when the main source of power to the container system 132 is supplied by the power transmission lines 141, the battery 144 can serve as an auxiliary power supply for the uninterrupted power supply UPS 145, which powers the processor 148, in the event that power from the power transmission lines 141 fail.

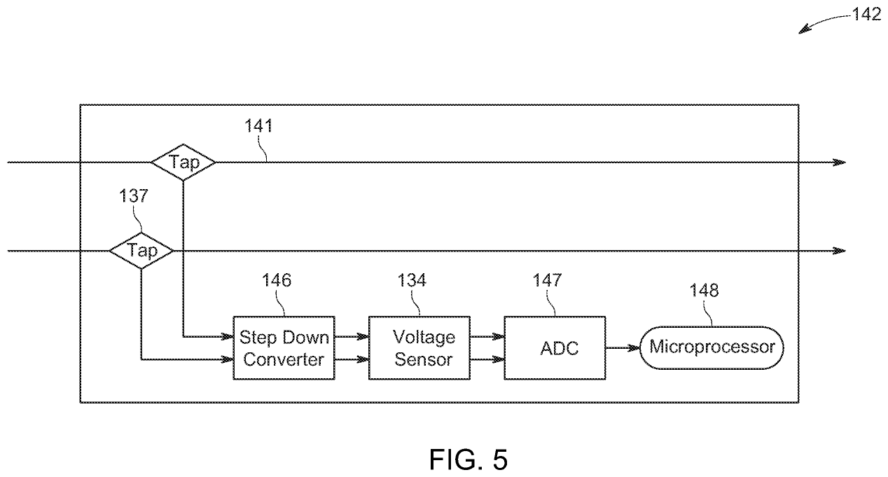

Further, when the power is supplied by the power transmission lines 141, the power distribution device can also include a converter 146. The voltage converter 146 can be used to step up or step down the voltage as needed, as one of various forms of power conditioning. For example, a 110/220 voltage may be converted to a 220/240 and vice versa. In another aspect, the power distribution device 142 can include an AC to DC rectifier 147 which converts direct current to alternating current and vice versa. Converting input power may be necessary because the first type of monitoring sensors 134, the second type of monitoring sensor 135 and the collecting sensors 150 can function under alternating current AC but the power may be supplied with direct current (DC). In an alternate wiring embodiment as shown in FIG. 5, power distribution device 142 can also comprise a voltage sensor 135 associated with the second type of monitoring sensors. The voltage sensor 135 can be used to determine the voltage supplied to sensors. In a further aspect, the power conditioning can also include using rectifiers, inverters or converters that step up or step down the voltage.

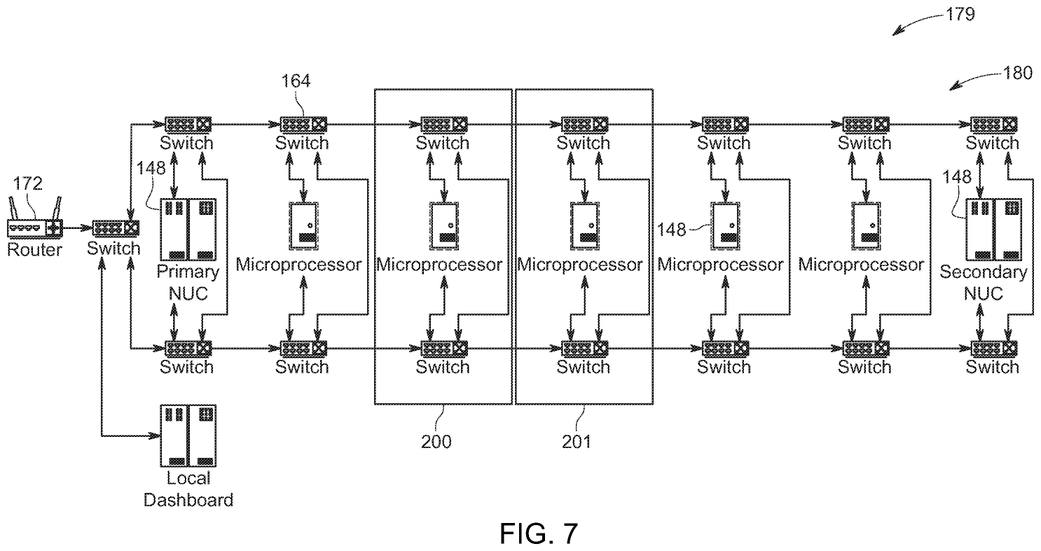

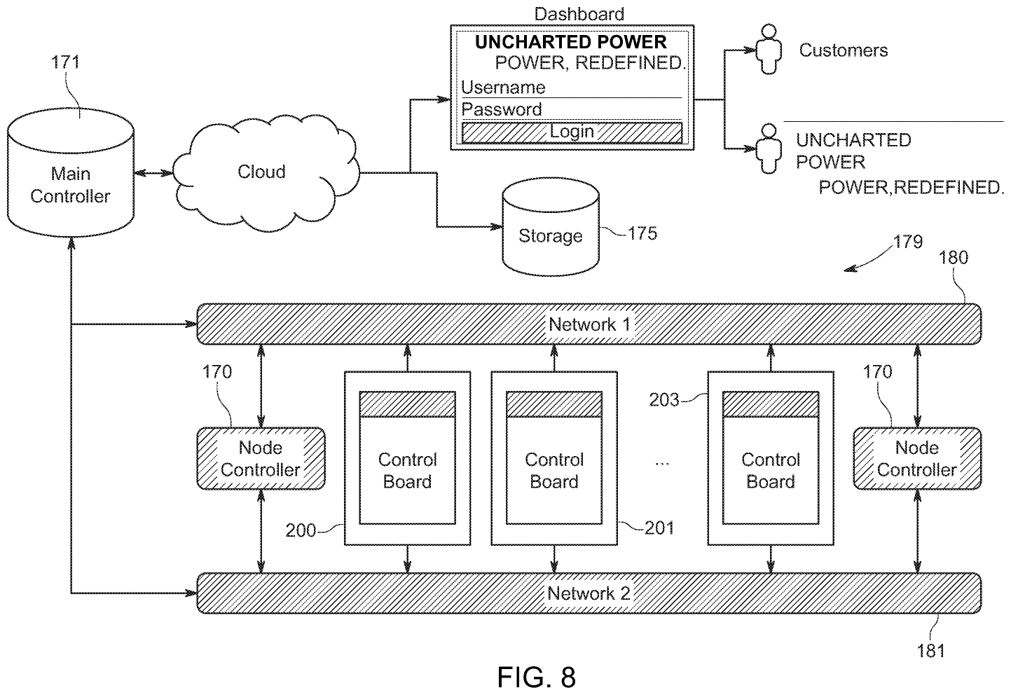

In a further aspect, the power distribution occurring in a single container 200 and within the container system 132 can be used to distribute power to a second container. As shown in FIGS. 7 and 8, the containers can form a distributed network 179. In a further aspect, the power transmission lines 141 can connect to each of the containers. In yet another aspect, power transmission lines from various power sources can transmit through the distributed network 179. In this embodiment, in the event that the power transmitted to a respective second container is disrupted, the power distribution device 142 in a first container can be altered to provide power to the second container 201. Accordingly while providing power to the second container, the power distribution device 142 can alter the power provided to the first container 200 and the first container system 132 such that the first container still maintains the appropriate amount of power. Similarly, the distribution process can be expanded to provide power to a third container 203.

In a further aspect, the container 200 can have a plurality of photodiode sensors 156 such that if any or various locations of the container are accessed, then a signal would be provided. For example, if the embodiment of the container includes the container system cover 133, then one photodiode sensor 154 can be placed under the cover 133 and a second photo diode sensor can be placed in proximity to the top surface 102. Accordingly, the processor 148 can receive signals that indicate when light has reached those regions of the container 100. In a further aspect, the collecting sensor 150 can include a tilt sensor 158 similar to the vibration sensor 151 to detect motion of the container. The external data captured by the collecting sensors is inputted from vehicles, pedestrians, air quality, or sound quality monitored in relation to the container. In a further aspect, the humidity sensor 137 can provide information about the moisture level inside the container 200 and/or the container system 132 as a function of environmental conditions, providing an early detection system to avoid electronic shorting, damage, or general faults.

Gas sensors 139 can be utilized to detect a variety of exhaust fumes from system, entering the system, and to monitor the microclimate surrounding the system. If the conduit carries gas mediums the gas sensors can provide protection and data for an early warning system for leak detection and help avoid explosions or other chemical hazards. Humidity and gas sensors typically operate by detecting electrical charges, electrical resistance, or electrical current changes on or across or on a material set.

In a further aspect, the container system 132 can comprise a data distribution system 162. In a further aspect, the data distribution system 162 can comprise network switches 164 and a processor 148. The processor 148 can be tasked with processing the container system data. The container system data can comprise the data generated internally by the container system 132 and data received into the container system. For example, when a collecting sensor 150, and the first or second type of monitoring sensors receive input from a stimuli, a signal can be generated. The processor 148 can function as a data receiving device for the container system. For example, the data receiving device can process the received container system. In a further aspect, the data receiving device can also store unprocessed data or processed data.

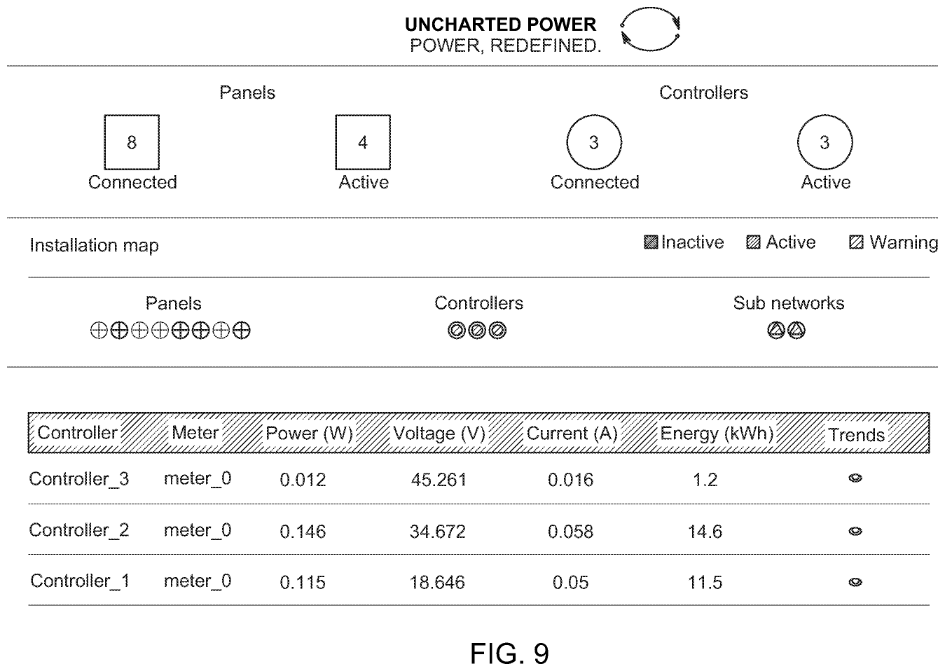

Processing the container system data can include distributing the data to other components of the container system or container 200; outputting the data for display to an auxiliary system such as the graphical user interface depicted in FIG. 9; or generating a feedback response based on pre-programmed instructions stored by the processor 148. The display can summarize container system data. The container system data can be used to indicate a status of an individual container system or multiple containers. Accordingly, as system administrator can quantify or qualify the status of the container system as the health of container or container system. In a further aspect, the processor 148 can communicate with other components of the container system 132 or container 200 through the network switches 164. The network switches 164 can function as a data distribution device 165. For example, network switches 164, functioning as data distribution devices can communicate with the other components of the container system 132 via a data conduit 152. The data conduit 152 can be an internal communication conduit to send and receive signals between the components of the container system 132 and the container 200. The data conduit 152 can also facilitate external communication from the container system 132 In this embodiment the network switches 164 may be used to determine which path of the data conduit 152 to take.

In a further aspect as shown in FIG. 4, the first type of monitoring sensor 134 can be attached to the network switches 164 and the processor 148. The monitoring sensor 134 can be configured to measure and monitor multiple types of container system data and it monitors conduit properties. In one aspect, the system data can comprise a status of container system. (e.g. the container system being active versus container system being inactive or a container being connected versus container being unconnected.) The status of the container 200 or the container system can be used by the system administrator to determine an overall health of the container and/or the data network 180. In another aspect, monitoring the container system data can include identifying, switching, or regulating a network component associated with a container 200. For example a main controller 171 may be adjusted to regulate the container system 132.

In addition, the processor 148 can communicate with the container system 132 and interprets the outputs the container system data. The output from different sensors are affected by noise or bias differently. For example, an accelerometer data may drift away from the zero position and may need regular calibration, where as a microphone sensor is very easily affected by electromagnetic activity around the sensor, and a voltage sensor is very sensitive to harmonics or noise in the system. Different filters, either hardware and software based, are designed to filter out the noise and bias in the data to report accurate data from the sensors. Examples of these filters include but are not limited to software based re-calibration of accelerometer data, and a hardware R-C circuit for a voltage sensor. This would improve the integrity or data quality and provide improved integrity of container system data.

In an alternate embodiment, the container system can also be configured such that the conduit extends from the entrance port and the exit port and transmits through the container at least one of: electricity, light, solid, liquid, or gas. The container system 132 provides a protected space for the monitoring sensors 134, 135 and/or collecting sensor 150 that are connected to said conduits carrying electricity, light, solid, liquid, or gas.

In a further aspect, the data distribution system of one container can transmit data to a second container. As shown in FIG. 4, containers can communicate with each other via the data distribution system 162 within each container. In a further aspect, the monitoring completed by a single container 200 can be extended to generate monitoring and data distribution between multiple containers 201, 203, as shown in FIGS. 7 and 8. The containers 200 can be connected to each other via Ethernet, Internet, or wireless communication such as Bluetooth or RF signal. In addition, the containers can be connected to a controller or node controller 170. In some cases, the controller 170 may be housed near the power destination. In this embodiment, the power distribution network 179 and the data distribution network can work in concert with each other.

As shown in FIG. 7 and FIG. 8, the network of data distribution devices 180 in each container system can form a distributed data center. In some embodiments, the one or more containers can use several electrical and/or mechanical components including power transmission lines, processors, switches, and Ethernet connections.

In addition to one or more containers, the distributed data center 180 can comprise one or more controllers. The one or more controllers may be housed outside of the container. In some cases, the one or more controllers may be located within the power destination, or near the power destination. The one or more controllers can support a function of the other components of the distributed data center 180, power source, power destination, or a combination thereof. For example, the controller 170 can connect to a processor 148 or a system of processors 148 within one or more containers. Further, the data distribution center 180 may connect the one or more controllers 170 to processors 148 as a network. Accordingly, this network may allow the exchange of information. For example, data may be collected from one or more power meters (not shown). The data can then be transmitted to processors 148 through the network for further processing. In some cases, the respective container system data can be transmitted to a cloud-based system instead of the processors, especially if the data is for emergency purposes or is to be processed in another facility. The one or more controllers 170 can be responsible for determining where the data is to be transmitted.

The one or more controllers 170 can provide several functions to the system. In some cases, the one or more controllers are important for metering as the controller determines what type of data is to be collected. In some cases, the one or more controllers are important for networking; for example, the controller can utilize a dynamic host configuration protocol (DHCP) to inform the network of the different available network connections. In a further aspect as shown in FIG. 10, summary data from the network connections and the individual containers can be output for visual display. For example, the computer's data can represent the containers 200 that are active and connected.

In some cases, the one or more controllers can collect data or otherwise facilitate data collection. For example, one or more processors 148 can collect the data via the first type of monitoring sensors 134. The collected data can be transmitted to the controller 170 for processing, local storage, or cloud storage. In some cases, the controller may determine if the unprocessed data should be transmitted to the processors to be computed. Additionally, the controller 170 may also determine if the data should be transmitted to the storage equipment to be stored.

In a further aspect, the one or more controllers 170 may also be used for monitoring safety status of the container. In some cases, the one or more controllers monitor a number of variables related to safety such as the overvoltage relays, overcurrent relays, switches, to name a few, throughout the system. Additionally, the controller 170 can check the status of one or more system safety devices to confirm the system safety devices is operating at status quo. In yet a further aspect, the data processed by the controller/controllers can be further processed by the main controller 171. At the main controller 171, data can also be routed, calculated or processed for storage.

In addition to the functions described herein, the one or more controllers 170 may play additional roles. For example, smart monitoring may be integrated into the controllers 170. In another example, the one or more controllers may connect with each other to communicate over a direct line for the purpose of transmitting errors, alarms, and other important or non-essential data.

The one or more controllers can be scaled up to comprise as many controllers as is needed to meet demand requirements and/or to increase the functionality of the system. In some cases, the data may need to be uploaded to a cloud-based data storage system 175. In those cases, at least one controller 170 should be connected to the Internet. This cloud-connected main controller 171 is then able to communicate with the other connected controllers. However, if there is no need to store data on a cloud-based system, the controller does not need to be connected to the Internet.

In some embodiments, the container system 132 may contain one or more processors 148. The processors may be responsible for processing some or all the data collected. The data to be processed may not have to be collected on the same site. Data can be sent to the distributed data center to be processed. For example, a company may send pre-existing data packages (protocols) to the system to be processed and then returned back. The data can be collected on site and then sent to an alternate site to be processed. In a further aspect, data can be received by a first container system 132 and sent to a second container system. Again, the controller 170 or protocols may make a determination as to which container system 132 will process the data. The decision may be based on system utilization of processor and the capacity of the processor.

Each of the one or more processors 148 can comprise a single core, a dual core, or a multiple core. The number of cores can be as high as needed to support the requirements of the system. The more cores that are included, the more computer systems can be used at a single point.

The processors may be connected to the controllers, which determine how they operate through the network 180. In addition to connecting to the controller 170, the one or more processors 148 can be connected to other processors through the network 180. The processors can be connected to each other and to the controllers in any combination that is feasible. The container can comprise as many processors as needed by the system.

The system comprising the distributed data center 180 may comprise a network 181 for hardware, such as a physical connection between the one or more controllers and the one or more processors. The connection between the one or more controllers 170 and the one or more processors 148 can enable the exchange of data between a controller and a processor. In addition, the network 181 may contain additional components such as one or more switches or media converters; one or more Ethernet and/or fiber optic cables, or similar. In addition to wired cables, the network can also be supported through wireless connections such as Wi-Fi and sound waves.

In some cases, the network may be configured to enable distributed data computing and data storage. Similarly, the controller can dictate where the data should be directed to for computation and storage.

As mentioned earlier, the controller can utilize a dynamic host configuration protocol (DHCP) to inform the network 181 of the different available network connections. In some cases, the software allows for automatic naming of sub-systems such as the one or more processors. In some cases, the software can assign an IP address or Internet protocol to the system and/or parts of the system. In other cases, the software may resolve an IP conflict. In other cases, during a container system deployment, the controller can assign a “host name” and “IP address” to the system and parts of system, when new devices are added to the system the software adds the device to the database with new hostname and IP address, whereas for replacement of a faulty or failed device, the original hostname is used to identify the “new” device as a replacement and the controller updates the information. The host name can be an assigned value such as identifier or a fixed value such as Mac address.

In some embodiments, the container 200 may contain one or more RAID (redundant array of independent disks)-based data storage. The data can be stored on the RAID storage before and/or after the data has been processed by the one or more processors. In some cases, data may also be stored, processed, and then uploaded to a cloud-based system. The RAID storage may include one or more physical hardware, such as a Solid State Drive (SSD), a Hard Disk Drive (HDD), M2, to name a few. In addition to the RAID data storage system, there can be multiple levels of redundancy. The level of redundancy level can be increased based on a number of factors, including the amount of data processed by the processors.

Another advantage of the system provided herein is its modularity and scalability. The data center is decentralized to create a modular data center. The modular configuration allows the system to be scaled up or down as needed. In some cases, the distributed data center can be expanded over time as the data needs to expand. The foremost clear benefits of a modular and scalable configuration are reduction of the barrier to entry such as upfront capital and enabling upgradeable systems.

The system can also have a self-sustaining power source since the system can be connected to one or more power sources, including power-generating sources. Power from the one or more power sources can be utilized to power one or more of the components contained within the container.

Many power transmission systems are located above the ground and exposed to many elements that leave the system susceptible to damage and failure. In addition, the exposed power transmission system can be a safety hazard, endangering anything in its surroundings.

Provided herein is a power transmission system that can be embedded below ground level. Locating the power transmission system below ground in this system provides several benefits including increased user safety, increased aesthetic appeal, increased speed of repairability, improved modularity and scalability, better financial feasibility, and easy installation.

The embedded power transmission system can comprise one or more containers in an arranged formation. For example, described herein, one or more power sources, and one or more power destinations. In some cases, the system of container can beam power transmission system that transmits power from a power source (such as a power generating device) to a power destination (such as a power drawing device or a load). To perform its service, the container can be laid in any pattern to connect two or more points as needed. The two or more points can be any combination of power generating (or power harvesting) power supplies, power-neutral devices, and/or power drawing devices. In some cases, the containers can be leveraged to create infrastructure for full electrical micro-grids. The two or more points can be any infrastructure or device that is appropriate for the intended application.

The one or more containers of the power transmission system can be modular, and can be configured to be connected to one another. This allows for the scale and functionality of the power transmission to be increased or decreased as needed. The modularity allows for scaling of the power transmission system over time. It also eliminates the need for additional major construction and/or damage to existing infrastructure.

The scalability of the system can also diminish the upfront costs of the power transmission system. There is currently a large barrier for traditional power transmission and distribution systems. Since the power transmission system described herein can be more easily scaled over time, the capital required for product purchase and installation can be spread out over the scaled time period, rather than paid upfront. In some cases, the container can be designed to reduce the time of installation compared with that of traditional forms of underground cabling installation.

In some embodiments, the one or more containers and other components and accessories within the power transmission system can be prefabricated. In some cases, they can be partially or fully pre-assembled prior to arriving at the installation site, saving on assembly time and difficulty.

The customization of the containers may extend beyond aesthetics and into structural applications. The containers can be used for infrastructure applications, such as roadways, pathways, sidewalks, flooring, and/or any other form of ground-based infrastructure for outdoor or indoor purposes. The modularity of the containers enables the system to be as small as a single container or as large as is necessary for the intended application.

The one or more power sources include power harvesting devices such as solar containers, wind turbines, kinetic energy harvesting devices, piezoelectric generators, triboelectric generators, or any other form of power generation, transmission, storage, or harvesting. In some cases, the power source is an electrical grid. In some cases, one or more converters may be used to step up or down the voltage at the point of the generation or elsewhere before or after it is to be transmitted. In some cases, one or more rectifiers may be used to rectify the power at the point of generation or elsewhere before or after it is to be transmitted.

In some cases, the kinetic energy harnessing devices can be implemented directly in the containers themselves. For example, power harvesting systems can harvest kinetic energy exerted on system by pedestrian and/or vehicular traffic above a surface in which the containers, described herein, are embedded. By implementing the power source directly into the containers, the containers can become an integrated system for both power generation and transmission.

The one or more power destinations can comprise low power-consuming infrastructure such as indoor and outdoor lighting systems, street lighting systems, air conditioning (A/C) units, mobile charging stations, and/or WiFi kiosks, among others. In some cases, the one or more power destinations may comprise high power-consuming infrastructure such as residential buildings, hospitals, and schools, among others. The power destination can be any destination that includes an electrical load (e.g., an electronic device, or anything that uses, consumes, or stores electricity or power).

In order to transmit power from the power source to the power destination or elsewhere, one or more wires such as transmission cables may be housed in the one or more containers. The one or more wires can connect from the power source (such as a power generating device) to the power destination (electrical load), directly or indirectly. In some embodiments, the bottom surface 104 of the containers can be laid in the ground first; then the transmission cables 141 can be laid down over the bottom surfaces; next, the top surface 102 and side surfaces 108 are secured to the bottom surface 104. In other embodiments, the transmission cables can be threaded through the ports in the containers as opposed to laid down.

In some cases, the containers can be designed such that individual transmission conduits are secured to each container and disconnected from one another, thus creating a plug-and-play system with the containers. As each container is laid in the ground, the next container may conveniently plug into the one adjacent to it. In this setup, the system can be easily scaled and/or the design can change at a later point in time with no damage to the containers and their transmission cables and with little effort, so long as the plugs remain compatible.

In some embodiments, a plurality of protection systems may be included in the system to protect the system against over voltage, over current, or ground fault, among other problems. In some cases, the power transmission components can be made waterproof by housing all electrical components in a waterproof container, such as a NEMA box or similar.

Described herein are power systems for power generation, storage, and transmission. In some embodiments, a power system comprises a container as described herein. In some cases, the power system comprises two or more containers. In some embodiments, a power harvesting device, as described elsewhere, is integrated into at least one of the containers. Integration of the power harvesting device into the container may require changes to the container structure or design. In some cases, the change to the container structure or design is minimal.

In some embodiments, the power system may further comprise an power storage system. In some cases, the power storage system is integrated into at least one of the containers. The power storage system can collect and store power from the power generator. The stored power can be utilized for larger power applications that require one consistent stream of power. For example, the power storage system can be an electrochemical cell, lithium ion battery, rechargeable power storage systems, capacitors, supercapacitors or ultracapacitors, fuel cells, other cells, or any other power storage system (e.g., a system that stores potential power that can be converted to electrical power).

In some cases, the power harvesting device harvests power (e.g., generates electrical power) by harnessing power that is applied to the power harvesting devices. The power may be harnessed from vehicular activity. In some cases, the power may be harnessed from pedestrian activity. In some cases, the power harnessing system may be integrated into an electrical grid or an external electrical system. The ability to install a power harnessing system any distance away from an electrical grid or an external electrical system allows for the creation of a power system with unrestricted modularity and scalability, and ease of installation and repairs. Such systems for power generation, storage and transmission can be used to provide power in remote parts of the world without electricity.

In some embodiments, one or more micro-generators may be embedded in each container. In some cases, the micro-generator can harness energy from pedestrian and vehicular traffic. The use of embedded micro-generators provides several advantages. For example, the micro-generators mitigate spatial and/or geographical constraints typically encountered with the construction of conventional power generation, transmission, and distribution systems. In addition, the use of micro-generators within the containers provides users with reliable, self-sustaining, on-demand electricity.

In some embodiments, the power transmission system may include an embedded power metering system that tracks power data. In some cases, the power data relates the amount of power generated by the power generating device, the amount of power available from the power source, the amount of power available for use by the power transmission system, the amount of power needed by the power destination, or a combination thereof.

In some cases, the embedded power metering system can comprise one or more direct current (DC) power meters, one or more alternate current (AC) power meters, or a combination thereof. The power meter may be purchased off-the-shelf or custom-designed, or a combination therein. The meter may collect information such as current and voltage, among others. In addition, other variables such as power and power can be derived from the power meter.

In some cases, a smart power meter can be used. A smart power meter may provide several advantages over a regular meter. A regular meter connects to a server to transfer data collected by the meter to the server. A smart power meter, however, may contain internal storage to store the data collected. In the event that the server is down, data can be temporarily stored for weeks or more, as needed. A smart power meter may be able to connect to the Internet directly so that it can directly upload or publish data to a cloud system or otherwise communicate directly. The smart power meter may comprise a network adapter, for example, to communicate with a network (e.g., the Internet).

The power meter may be customized so that it can be integrated directly into the server. One benefit to this integration is that the system takes up less physical space. Another benefit is that once integrated into the server, the server is able to control the power meter, thus creating a smart meter. The server may be programmed to collect certain information on its own according to set protocols.

Once the data is collected from the meter, it can be stored on site, sent to the cloud via a server for storage, or a combination of the two. The data may later be analyzed, evaluated, and used for other applications. The data can help to understand the power production and/or usage of the system. The operators of the system can identify how much power the system itself used and how much power the loads used. For example, from this data, the consumers can be billed according to their load usage.

In some cases, data relating to system power usage can be used to generate predictions as to what loads will need power and of what amounts in the future. The system may be able to integrate protocols to prepare for such predictions by ensuring enough power is available for the associated loads and/or at certain times of the day.

In some embodiments, the power transmission system may include a monitoring system. In some cases, the monitoring system tracks one or more performance metrics of one or more transmission lines embedded underground. By monitoring one or more performance metrics, any breakage or fault of transmission lines may be quickly and easily detected, and may be repaired faster when compared to a similar situation without the above monitoring system.

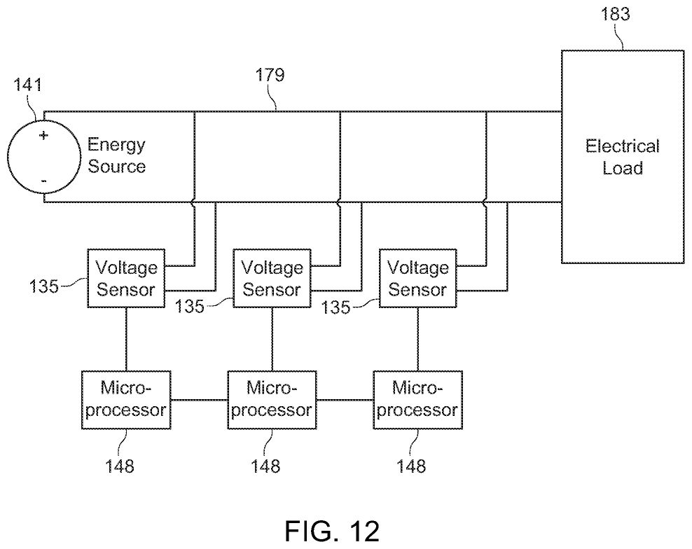

FIG. 12 provides an example layout of a smart monitoring system for electrical transmission lines 141 in the container system 132. The smart monitoring system can also be scaled to make additional analysis of a distributed data system 180 or power distribution system 179 that spans multiple containers. The smart monitoring system comprises an power source 160. The power source 160 can comprise a power harvesting device, for example. Examples of power harvesting devices include devices for harnessing power from solar power or kinetic power, triboelectric generators, piezoelectric generator, and the like. The smart monitoring system can be powered by the same source as the overall system described here or supplied by a different source. In some cases, the power source is an electrical grid, or a device connected to an electrical grid.

The power source 160 can be a direct current (DC) or alternating current (AC) generation source. In the case of an AC power line, a rectifier can be used to convert AC to DC. The converter 146 may be placed between a plurality of sensors and the transmission line(s) being monitored. If the power source is a DC input, a converter 146 may not be required. However, the DC input may be converted to higher or lower DC voltage using a DC-DC converter.

The system can comprise a plurality of sensors 134 to monitor one or more performance metrics for one or more electrical transmission lines (e.g., 141), electrically connecting the power source 160 to an electrical load 183. In some instances, the plurality of sensors 135 may comprise one or more voltage sensors. The voltage sensors 135 may be used to determine the presence, absence, and/or amount of voltage in one or more sections along an electrical transmission line 141. The voltage sensor 135 may be customized to include a printed circuit board (PCB). Customized voltage sensors 135 may be integrated into one or more processors.

For monitoring purposes, at least one sensor from the plurality of sensors 135 can be located on a transmission line 141 that is being monitored. For example, the sensor may be a voltage sensor. In some cases, one or more voltage sensors 135 may be used per transmission line. When one or more voltage sensors are used, a voltage differential may be measured between the two locations on the transmission line where the voltage sensors are located. Measuring a voltage differential, or lack thereof, can facilitate determination of the location of a potential line break or fault.

In scenarios wherein there is a fault or breakage in an electrical transmission line, the voltage sensor reading will either change drastically or read zero across adjacent sensors. The processor will receive this data and communicate this fault and its location to the controller.

The plurality of sensors 135 can be located at any point between the power source 160 and power destination or electrical load 183 as shown in FIG. 12. Barring any defects, external interruptions, additional devices, and/or other such interferences, the measured voltage will be the same throughout a transmission line 141.

The smaller the distance between each sensor, the more sensitive, effective, and efficient the sensor subsystem can be. For applications with long transmission lines, this can be achieved by adding multiple sensors. The number of sensors per distance can affect the detection and resolution of any faults. If the distance between any two sensors located along a transmission line 141 is short, any fault in the line can be detected with speed and precision as a short distance needs to be searched to locate the fault. In some cases, a DC-DC converter can be used to step down the voltage before the voltage sensor takes a measurement. The use of a DC-DC converter can make it easier for the voltage to be read.

The plurality of sensors 135 can be used to obtain different information about the performance of electrical transmission lines 141. The plurality of sensors can be used to measure voltage, current, ground fault, and the like. The measured data can be analyzed and processed by one or more processors 148, electrically coupled to the plurality of sensors 135, to obtain a variety of derived information. The derived information can provide further insight into the performance of the electrical transmission lines. The plurality of sensors may quantify other variables such as power quality, phase, reactive power, and power factor, to name a few.

In one embodiment, the system comprises a plurality of voltage sensors that determine the presence of a voltage and/or a positive voltage differential in an electrical transmission line. For example, the plurality of sensors can determine an exact voltage amount within a transmission line at any given time.

The smart monitoring system can also comprise a power destination such as an electrical load 183. An electrical load is an electrical component or portion of a circuit that consumes electric power. The electrical load can be any power drawing device. It can be an entire building, such as a residential home or school, or an individual device such as a street light, a WIFI hotspot, or air conditioning unit, and the like.

The smart monitoring system can comprise a plurality of processors 148. The plurality of processors can be responsible for reading the sensor data collected by the plurality of sensors, processing the sensor data to detect any faults, and communicating the data and analyses. In some cases, some of the processors can be microcontrollers. Data lines can connect the plurality of sensors 135 to the plurality of processors 148 for communication.

In some embodiments, the plurality of processors 148 can communicate to a controller 170 through a network. The plurality of processors can be programmed based on what variable needs to be extracted. For example, real power can be calculated by extracting data regarding voltage and current of the lines through voltage sensors and current sensors. Data integrity is the processes used for protection or preservation of information reliability and continuity throughout its life cycle. Ensuring physical integrity requires measures such as redundant components, a backup power supply, RAID arrays, utilizing file systems with block-level checksums such as ZFS, or using a cryptographic hash function and even a watchdog timer on sensitive subsystems. Common methods to maintain logical consistency include elements such as a check constraints, foreign key constraints, program assertions, and other run-time sanity checks. Several of these methodologies such as backup power supply, RAID storage (where necessary), check sums, redundant components, check constraints can be used to maintain data integrity in for the container.

The smart monitoring system can comprise a hardware-based network. The hardware-based network can be a physical connection between the one or more controllers and the plurality of processors 148. This connection enables the exchange of data between the controllers and the processors. The network may comprise two parts: (1) switches and/or media converters; and (2) Ethernet and/or fiber optic cables. In addition to wired cables, the network can also be supported through wireless connections such as Wi-Fi and sound waves. Alternatively, the network connects the one or more controllers to the plurality of processors and supports the exchange of information.

The smart monitoring system can further comprise a user interface. In some cases, the user interface is connected to the one or more controllers to obtain data. The data can be viewed by a user to learn about the status of the electrical transmission lines as determined by the sensors and the processors described herein. As shown in FIG. 9, the user interface can alert a user to the detection of one or more faults within the electrical transmission lines. Once alerted, the user can then choose to deploy an appropriate maintenance protocol to correct or repair the fault. In some cases, the user interface is a digital surface or virtual surface. In some cases, the user interface is a website. In other cases, the user interface is an application that requires the user to log in. In some embodiments, the user interface can display or otherwise output (e.g., via sound) an automatic alert. The automatic alert may alternatively or additionally comprise an email or text message sent to a user's mobile device.

The smart monitoring system provided herein can be used in a number of applications. In one exemplary application, the plurality of sensors within the system comprises one or more voltage sensors. The one or more voltage sensors check for the presence or absence of voltage in the transmission line being monitored, and communicate the results back to the plurality of processors. When there is a break or fault in a transmission line, the last sensor located before the break will read the open circuit voltage. The voltage differential determined using the last sensor can be used to locate the break or fault in the transmission line. In this exemplary embodiment, the plurality of processors can be powered by a battery or a power harvesting device. The power source may be located within the system or connected to the system via a power line.

In another exemplary application, the plurality of the processors is equipped with power from a transmission line and an uninterruptible power supply (UPS). In some cases, a DC-DC converter may be used to step down the voltage. When there is a break or fault in the transmission line, the plurality of processors can switch over to the UPS system and will notify the one or more controllers of the change in power source. This change in power source can signal the development of a fault in the transmission line.

Beneficially, the smart monitoring system provided herein has the ability to pinpoint the location of a fault in an electrical transmission line with great speed and accuracy and provides advantages such as variable-resolution fault location identification, smart data acquisition, and proactive fault monitoring.

Variable-resolution fault location identification: the system has the potential to detect a breakage or fault better than any other method currently available to the public. The resolution of fault detection can be increased to a very high degree by simply adding more sensors to the system. The distance between the sensors directly affects the resolution.

Smart data acquisition: the plurality of processors can be programmed to collect certain information automatically from a system. Valuable data can be collected while the system is operating normally. This data can be used in a variety of different situations and for a variety of purposes beyond just monitoring of the system, providing even more value.

Proactive fault monitoring: with commonly-available underground electrical transmission systems, it is extremely difficult to locate faults. Visible detection requires a maintenance professional to descend below ground to investigate when a fault is identified. Often, fault identification only happens after a negatively-affected end user reports a lack of power. This is a reactive detection method as opposed to a proactive detection method. With the smart monitoring system described, proactive fault monitoring can be achieved. A fault and its location can be detected automatically and almost instantaneously. A quick and accurate identification of the fault can allow the fault to be fixed before it negatively impacts end users.

The application of the smart monitoring system is not only limited to electrical transmission lines. It can also be used to monitor data cables including but not limited to Ethernet, coaxial, fiber optic, serial cables, and token ring cables, among others.

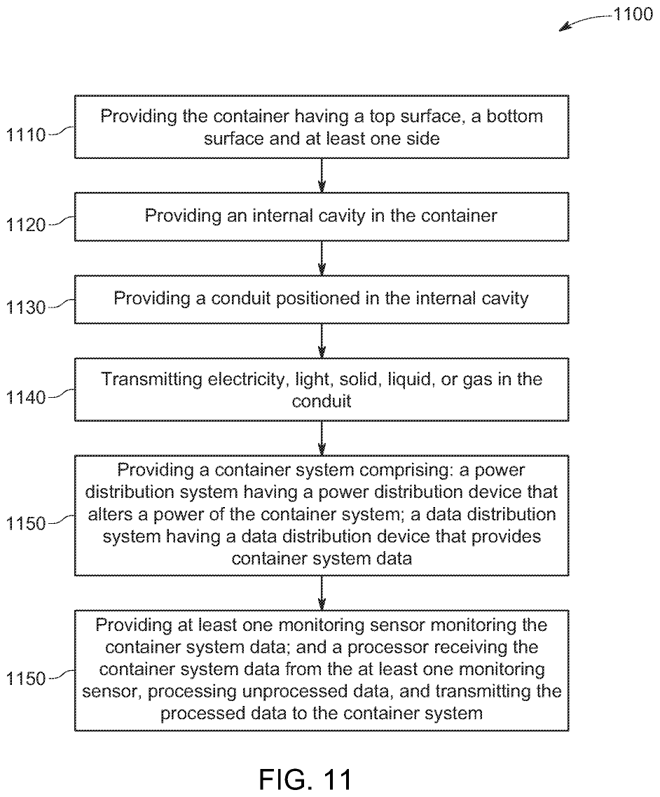

FIG. 11 illustrates a flowchart 1100 of the method 1100 for monitoring a container. The method can initiate a block 1110, wherein the step comprises providing the container having a top surface, a bottom surface and at least one side surface oriented between the top and the bottom surface. Method 1100 can proceed to block 1120, which can comprise providing an internal cavity in the container. Method 1100 can proceed to block 1130, which can comprise providing a conduit positioned in the internal cavity. Block 1140 can comprise transmitting electricity, light, solid, liquid, or gas in the conduit. Block 1150 can comprise providing a container system. The container system can comprise a power distribution system having a power distribution device that alters a power of the container system. The container system can further comprise a data distribution system having a data distribution device that provides container system data. The container system can also comprise providing at least one monitoring sensor monitoring the container system data. The container system can also comprise a processor receiving the container system data from the at least one monitoring sensor, processing a processed data, and transmitting the processed data to the container system. In an alternative embodiment, the method 1100 can include the at least one monitoring sensor monitors conduit properties. The method of monitoring the container system data can further include determining a status of the container. The method of monitoring the container system data can also further include monitoring the container system data further aspect, the external data can feature vehicles, pedestrians, air quality, or sound quality monitored in relation to the container.

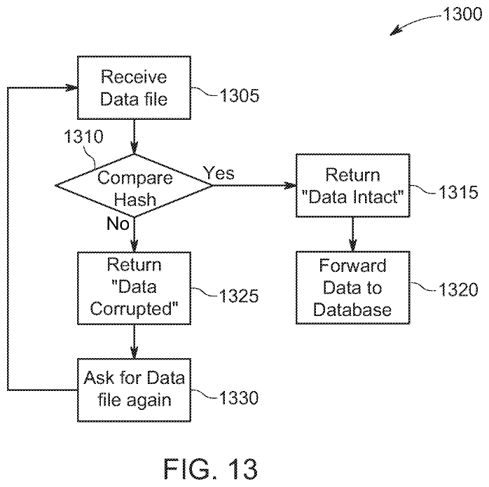

As shown in FIG. 13, there is a flowchart for evaluating the data integrity during data processing. The process can begin at Step 1305 when the data file is received. Method can proceed to Decision Block Step 1310 to Compare Hash is completed. In one aspect the Decision Block 1310 can follow a Yes branch to Block 1315 where the data is processed and returned intact. The method can proceed to Block 1320, where the intact data is forwarded to a database for storage. In a further embodiment, the decision block 1310 can process through the No branch to Block 1325 where it is determined that the unprocessed data is corrupted. After it has been determined that the data is corrupted, the method can proceed to Block 1330 where an additional request can be made to Ask for the Data Again.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosure, including the best modes, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A container comprising:
a top surface, a bottom surface and at least one side surface oriented between the top and the bottom surface,
wherein the at least one side surface defines at least one exit port and at least one entrance port to the container;
at least one conduit transmits through the container,
wherein the container defines an internal cavity;
a container system in the internal cavity;
a power distribution system, and
a data distribution system.

2. The container of claim 1 further comprising a first monitoring sensor monitoring container system data.

3. The container of claim 1, further comprising a load bearing member oriented on at least one of: the top surface, bottom surface or the at least one side surface.

4. The container of claim 1, wherein the conduit extends from the entrance port and the exit port and transmits through the container at least one of: electricity, light, data, solid, liquid, or gas.

5. The container of claim 1, wherein the power distribution system further comprises a power distribution device that alters a power of the container system.

6. The container of claim 1, wherein the data distribution system further comprises a data distribution device that provides data to and/or from the container system.

7. The container of claim 1 further comprising data conduit transmitting the container system data to and/or from the container system.

8. The container of claim 1, wherein the data distribution system further comprises a data receiving device that provides data to the container system.

9. The container of claim 1, wherein the container system data features container system health.

10. The container of claim 1, further comprising a second monitoring sensor that monitors the conduit properties.

11. The container of claim 1, wherein the container system data comprises a data integrity.

12. The container of claim 1, further comprising a processor receiving data from the first monitoring sensor or the at least one conduit, processing said data, and transmitting the processed to the container system.

13. The container of claim 1, wherein the top surface comprises a non-slip external surface.

14. A container comprising:
a top surface, a bottom surface and at least one side surface oriented between the top and the bottom surface;
at least one port;
wherein the container defines an internal cavity;
at least one conduit positioned through the port;
a container system in the internal cavity comprising:
a power distribution system,
a data distribution system, and
at least one monitoring sensor monitoring container system,
wherein the container system is housed in a container system enclosure that can withstand environmental conditions.

15. The container of claim 13 further comprising a power conduit supplying power to the container system.

16. The container of claim 13 further comprising data conduit transmitting the container system data to or from the container system.

17. The container of claim 13, wherein the top surface is load-bearing and further comprises a non-slip external surface.

18. The container of claim 13 further comprising at least one collecting sensor collecting data external to the container system to be processed.

19. The container of claim 13 further comprising a processor receiving data from the at least one monitoring sensor processing said data, and transmitting the processed data to the container system.

20. A method of monitoring a container comprising:
providing the container having a top surface, a bottom surface and at least one side;
surface oriented between the top and the bottom surface;
providing an internal cavity in the container;
providing a conduit positioned in the internal cavity;
transmitting electricity, light, solid, liquid, or gas in the conduit; and
providing a container system comprising:
a power distribution system having a power distribution device that alters a power of the container system;
a data distribution system having a data distribution device that provides container system data;
providing at least one monitoring sensor monitoring the container system data; and
a processor receiving the container system data from the at least one monitoring sensor, processing unprocessed data, and transmitting the processed data to the container system.

21. The method of monitoring the container of claim 19 wherein the at least one monitoring sensor monitors conduit properties.

22. The method of monitoring the container of claim 19 wherein the container system data determines a status of the container.

23. The container of claim 19 further comprising data conduit transmitting the container system data to or from the container system.

24. The method of monitoring the container of claim 19, further comprising providing external sensor collecting external data outside the container system.

25. The method of monitoring the container of claim 23 wherein the external data features vehicles, pedestrians, air quality, or sound quality monitored in relation to the container.
